(19) United States
(12) Patent Application Publication
(10) Pub. No.: US 2010/0237667 A1
(43) Pub. Date: Sep. 23, 2010

(54) Portable Folding Seat

(75) Inventors: Kevin Guy, Moorpark, CA (US); Guang Zhan, Wuyi (CN); Sufang Tong, Wuyi (CN); Siyuan Zhan, Wuyi (CN)

Correspondence Address: HOLLAND & KNIGHT LLP, 633 WEST FIFTH STREET, TWENTY-FIRST FLOOR, LOS ANGELES, CA, 90071-2040, US

(73) Assignee: PICNIC TIME, INC., Moorpark, CA (US)

(21) Appl. No.: 12/406,941

(22) Filed: Mar. 18, 2009

(51) Int. Cl. A47C 31/00; B60N 2/20; A47C 31/02

(52) U.S. Cl. 297/183.1; 297/354.13; 297/354.1; 297/228.13; 297/228.12; 297/229

(57) ABSTRACT

A portable folding seat including a back support, a seat portion and a pair of laterally-spaced mounting assemblies extending between and operatively connecting the back support to the seat portion so as to allow reciprocal rotational movement of the back support with respect to the seat portion between a carrying mode wherein the back support is positioned over and adjacent to the seat portion and a storage mode wherein the back support is positioned adjacent to and coplanar with the seat portion and from a storage mode to a seating mode wherein the back support is disposed at an angular orientation with respect to the seat portion and the mounting assemblies support the back support in selectively variable angles of rearward inclination in the seating mode.

### BACKGROUND OF THE INVENTION

The present invention relates to portable seats and, more particularly, to a portable seat having an adjustable back support and is readily foldable between a compact carrying mode and a flat storage mode.

Portable seats and backrests are well known and widely used in a variety of outdoor and indoor settings. Such devices are popular at athletic events where they are typically supported on bleacher or bench-type seats or a planar flooring and at outdoor activities where they are placed on the ground or the sand at the beach. These devices often have an adjustable backrest and may include a cushioned seat to provide a softer, more comfortable support. Such devices are typically foldable to facilitate carrying and storage. The support structures of these devices, however, are generally foldable or collapsible into a single folded disposition for storage and carrying which, while facilitating the carrying of the seat, is somewhat bulky and not well suited for convenient storage. This is particularly the case with padded foldable seats. The portable seat of the present invention provides a fully adjustable back support and allows the back support to be readily moved between a convenient carrying position adjacent the seat portion and a flat storage position generally coplanar with the seat portion. The present invention can obtain these results while providing a very comfortable padded yet compact lightweight structure.

### BRIEF SUMMARY OF THE INVENTION

Briefly, the portable folding seat of the present invention comprises a generally planar seat portion and a generally planar back support that is rotatably mounted to the seat portion such that the back support is movable between a compact carrying mode in which the back support is adjacent to and atop the seat portion and a flat storage mode in which the back support is positioned adjacent to and substantially coplanar with the seat portion. The rotatable mounting of the back support additionally allows the back support to be positioned and supported in varying angular orientations with respect to the seat portion without the need for additional supporting structure to provide a highly compact, versatile and comfortable seat.

### BRIEF DESCRIPTION OF THE DRAWINGS

FIG. 1 is a perspective view of the portable folding seat of the present invention in a sitting mode.

FIG. 2 is a perspective view of the portable folding seat of the present invention in the folded carrying mode.

FIG. 3 is a perspective view of the portable folding seat of the present invention in the flat storage mode and illustrating the interior frame in dotted lines.

FIG. 4 is a perspective view of the frame of the portable folding seat of the present invention illustrating the adjustability of the back support relative to the seat portion with phantom lines.

FIG. 5 is a sectional view taken along the line 5-5 in FIG. 1.

FIG. 6 is a sectional view taken along the line 6-6 in FIG. 3.

FIG. 7 is an exploded perspective view of one of the rotatable mounting assemblies in the frame of the present invention.

FIG. 8 is a sectional view taken along line 8-8 in FIG. 7.

FIG. 9 is a bottom view of the seat support of the present invention illustrating the use of a non-slip material on the seat cover.

FIG. 10A is an exploded side view of the elements in one of the rotatable mounting assemblies in the frame of the present invention.

FIGS. 10B-10K are side views of one of the rotatable mounting assemblies in the frame of the present invention, illustrating the operation thereof.

### DETAILED DESCRIPTION OF A PREFERRED EMBODIMENT

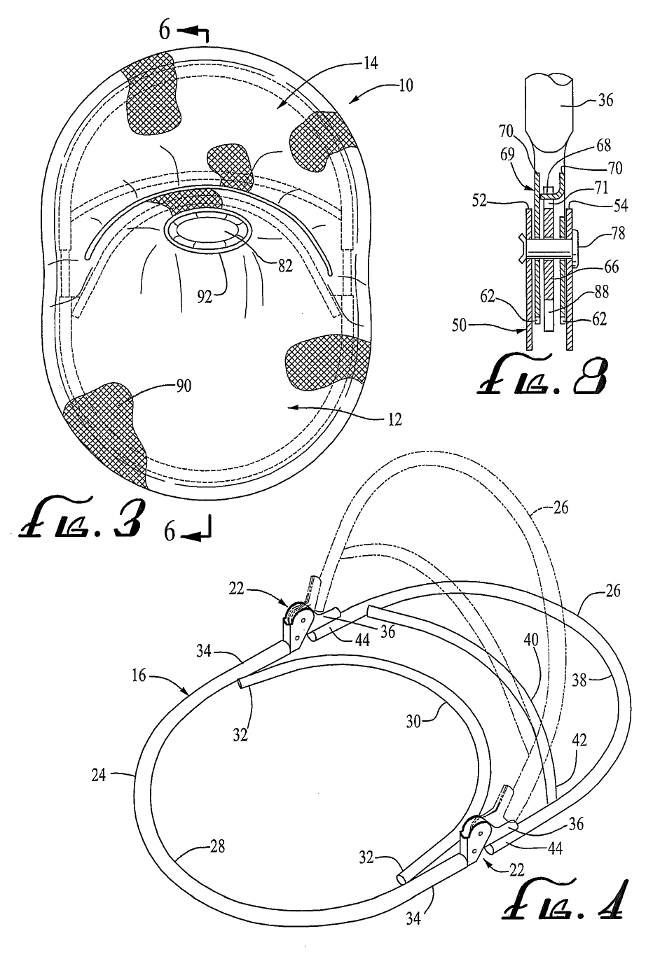

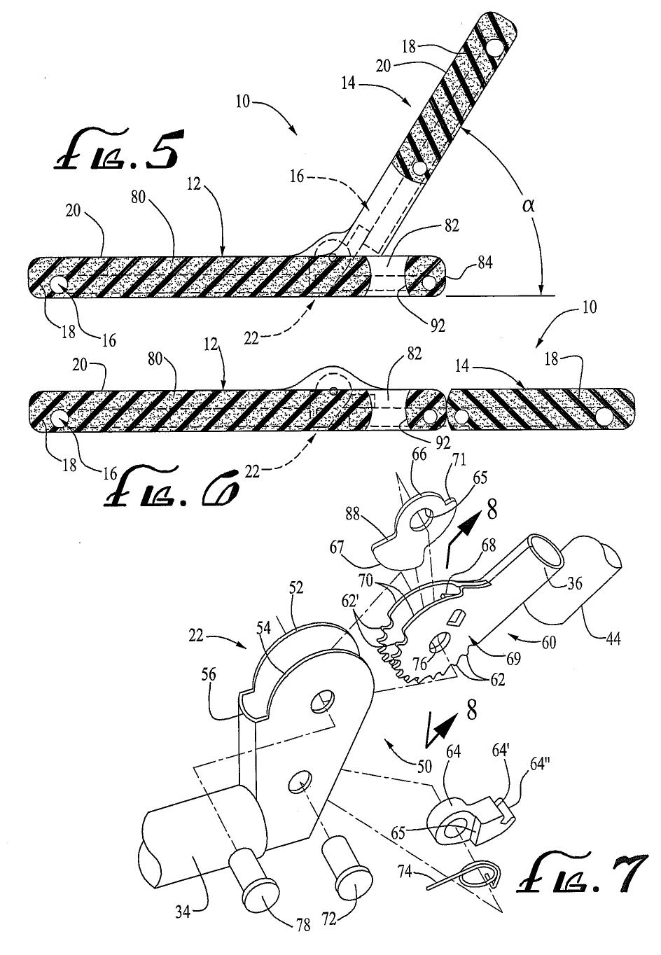

Referring now in detail to the drawings, a preferred embodiment of the portable folding seat 10 of the present invention comprises a seat portion 12 and a rotatably mounted back support 14. The seat and back supports are generally planar in configuration and are formed by a frame 16, padding 18 and cover 20. As will be described, the frame includes mounting assemblies 22 that allow the back support 14 to be rotated or pivotally moved relative to the seat portion 12 between a carrying mode in which the back support is adjacent to and atop the seat portion, as shown in FIG. 2, and a storage mode in which the back support is adjacent to and coplanar with the seat portion, as illustrated in FIG. 3. Between the carrying and storage modes is the seating mode in which the back support 14 projects forwardly and upwardly at an adjustable angle a with respect to the seat portion 12 so that a person can place the folding seat 10 on a level or substantially level surface, sit on the seat portion 12 and lean comfortably against the back support 14.

As seen in FIG. 4, the frame 16 of seat 10 comprises a seat section 24 and a back support section 26 that are operatively connected by the mounting assemblies 22. In a preferred embodiment, the frame 16 is formed of tubular steel, although other frame cross-sections and materials such as, for example, aluminum or a durable plastic material, could be used. The seat portion 24 of frame 16 is illustrated in an elliptical configuration although other configurations could be employed and is defined by arcuate sections 28 and 30 which are welded or otherwise suitably secured together at 32 proximate their extended ends. So secured, the seat portion of the frame defines two laterally spaced rearwardly extending ends 34 to which the forward ends of mounting assemblies 22 are secured. The back support portion 26 of frame 16 preferably comprises a first outer arcuate section 38 and a second inner arcuate section 40 that spans the first section 38 and is welded or otherwise suitably secured at or proximate its extended ends 42 to section 38. The extended end portions 44 of the outer arcuate member 38 are welded or otherwise suitably secured to the rearward ends of the mounting assemblies 22.

In the embodiment of the mounting assemblies 22 illustrated in the drawings, each assembly 22 comprises a generally C-shaped metal mounting bracket 50 defining opposed sidewalls 52 and 54 and a forward spanning wall 56. The spanning walls of brackets 50 are welded or otherwise suitably secured proximate their lower ends to the rearwardly extended ends 34 of arcuate section 28 in the seat portion of the frame such that the sidewalls project upwardly and slightly rearwardly therefrom (see, e.g. FIG. 4). Disposed within each bracket 50 between the sidewalls is a ratchet mechanism 60 comprising a plurality of ratchet teeth 62, a spring-biased pawl 64, a release cam 66 and a tab 68. In the illustrated embodiment, the ratchet teeth 62 are defined by a rotating member 69 that is welded or otherwise suitably secured to the extended end portions 44 of the back support portion 26 of the frame. Rotating members 69 are each stamped from a single flat metal sheet that is formed so as to define a tubular projection 36 at one end thereof and a pair of laterally-spaced, upwardly inclined and substantially circular flanges 70 at the other end. The ratchet teeth 62 are formed in the rearward and lower end portions of flanges 70 as seen in FIG. 7. The projections 36 on rotating members 69 are preferably sized relative to the frame to extend snugly into the end portions 44 of the arcuate member 38 in the back support portion 26 of the frame and are welded or otherwise suitably secured in place, thereby affixing the mounting assemblies 22 to the back support portion 26 of the frame 16.

A pawl 64, defining a pair of engagement teeth 64′ and 64″ is pivotally mounted on a rivet 72 extending between the sidewalls 52 and 54 of each bracket 50 and is biased toward ratchet teeth 62 by a torsion spring 74 carried by rivet 72 and bearing against an abutment surface 65 on the pawl and the interior surface of bracket spanning wall 56. The spaced flanges 70 defined by rotating members 69 are provided with aligned apertures 76 therein adapted to receive a second rivet 78 that also extends through the spaced bracket sidewalls 52 and 54, as shown in FIG. 7, to provide a pivotal connection of the rotating members 69 within and with respect to brackets 50 and thus a pivot mounting of the back support portion of the frame with respect to the seat portion. Also mounted on rivet 78 between the flanges 70 of the rotating members 69 is the ratchet release cam 66. Tab 68 in each ratchet mechanism projects between the flanges 70 and preferably is integrally formed with one of the rotating member flanges 70 and is bent at an angle of about 90° with respect thereto so as to project therefrom toward the other flange 70.

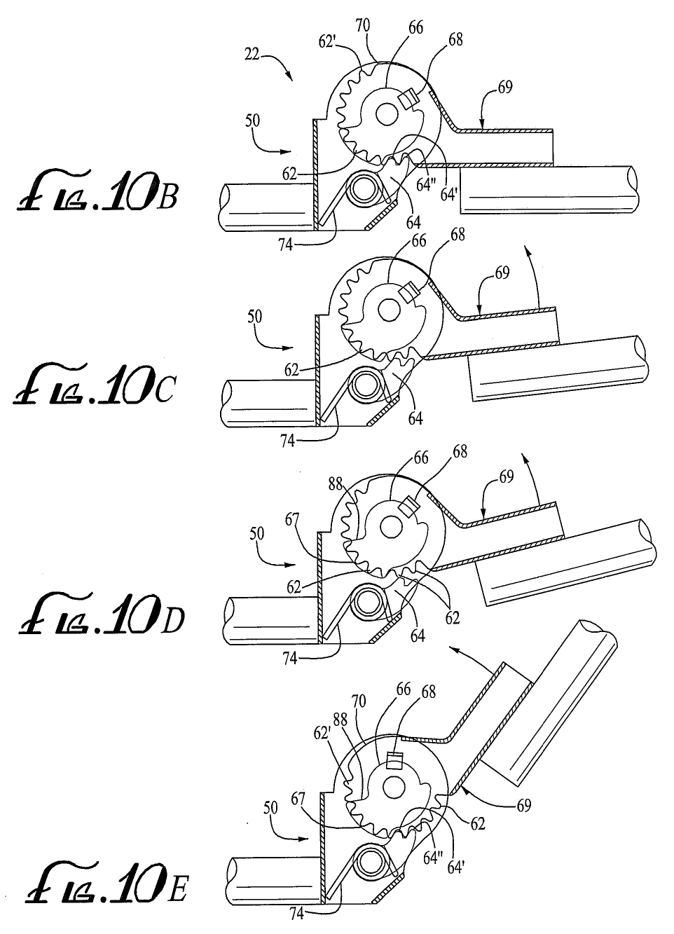

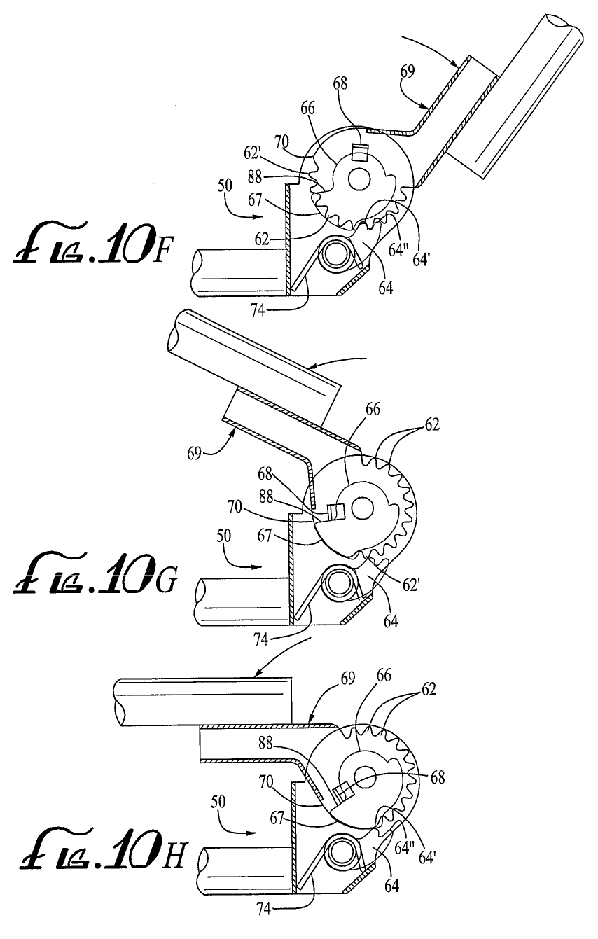

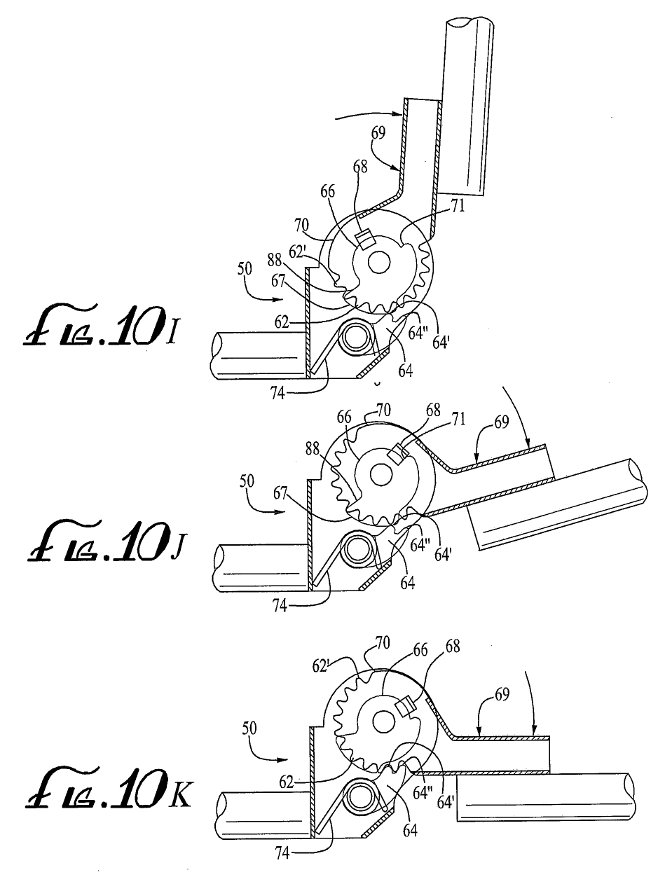

The release cam 66 in each mounting assembly 22 defines an aperture 65 therein having a diameter slightly larger than the diameter of rivet 78 so that the cam is freely rotatable thereon. The embodiment of the release cam 66 illustrated in the drawings also defines a camming surface 67, a first abutment surface 88 and a second abutment surface 71 on an opposed side of the cam from surface 88. The cams 66 are also configured so as to hang freely on their respective rivets 78 as illustrated in FIG. 10A wherein abutment surfaces 88 and 71 generally face upwardly from opposed sides of rivet 78.

The operation of the ratchet mechanisms 60 in the mounting assemblies 22 as the seat 10 is moved between its various modes is illustrated in FIGS. 10B-10K. In the following description, reference will be made to a single mounting assembly 22 and its components as the operation of the two mounting assemblies are identical and both assemblies move in unison as the back support 14 is moved relative to the seat portion 12. In the flat storage mode (FIG. 10B), the pawl 64 is biased by torsion spring 74 against the bracket 50 such that the engagement teeth 64′ and 64″ on the pawl extend between and engage aligned ratchet teeth 62 on the two spaced flanges 70 of the mounting member. As the back support 14 is pivoted upwardly and forwardly from the flat storage mode to its desired angular orientation in the seating mode, the engagement teeth on the pawl will successively engage, disengage and reengage aligned pairs of ratchet teeth on the flanges 70 whereby the angular orientation α the back support with respect to the seat portion of seat 10 can be selectively increased as the pawl ratchets along aligned pairs of ratchet teeth (see FIGS. 10B-10E). In the seating mode (see FIG. 10F), the engagement of the two pawls 64 with the selected pairs of ratchet teeth 62 on flanges 70 will support the back support 14 in an upwardly inclined orientation with respect to seat portion 12, with a person resting thereagainst, without the need for additional frame support.

Continued forward rotation of the back support portion beyond the vertical will cause the pawl to clear the last ratchet teeth 62′ whereupon the transversely projecting tab 68 extending between flanges 70 will abut the first abutment surface 88 on the release cam 66, causing the release cam 66 to rotate with the rotating member 69 and the back support 14. As the back support is continually moved forwardly to the carrying mode, the camming surface 67 on the release cam 66 is rotated into engagement with teeth 64′ and 64″ on pawl 64 (FIG. 10H). So engaged, the pawl is outside the path of engagement of ratchet teeth 62. As the back support is then rotated rearwardly from the folded carrying mode toward the flat storage mode (see FIGS. 10I-10K), the continued engagement of the pawl 64 with the camming surface 67, holds the pawl in a retracted disposition, preventing the pawl from reengaging the ratchet teeth on mounting member 69 so that the back support can be freely rotated back to the flat storage mode. Prior to the back support reaching the flat storage mode, the tab 68 extending between flanges 70 engages the second engagement surface 71 on the release cam 66 such that continued rearward movement of the back support effects a corresponding rotation of the release cam, disengaging the release cam from the pawl teeth, whereupon the pawl, under the force of the torsion spring, moves upwardly reengaging the ratchet teeth on flange 70. Upon the reengagement of the pawl with the ratchet teeth, the back support can again be moved forwardly to and secured in a desired angular orientation in the seating mode. Thus, the aforesaid mechanism allows the back support to be readily moved relative to the seat portion between the carrying and storage modes and fully supported at a wide variety of angular orientations in the seating mode.

To provide cushioning for the back and seat support portions of the portable folding seat 10, the frame 16 preferably is embedded in a layer or layers 80 of high density polyurethane foam such that the foam extends over and about the frame. By vertically offsetting the pivot point for the back support portion 26 of the frame 16 with respect to the seat portion 24, the padded seat and back portions 12 and 14 of seat 10 can be folded into a relatively flat adjacent disposition in the carrying mode without obstruction by the padding. In the illustrated embodiment, this offset is obtained through the use and mounting of brackets 50 and their upwardly projecting and slightly rearwardly inclined side walls 50 and 54 and the resulting elevated disposition of rivet 78 extending therebetween relative to the seat portion 24 of frame 16. This offset allows the padded seat portion and back rest to be folded into a flat compact disposition without pinching the padding therein which otherwise could lead to the deformation thereof.

Preferably, the layer(s) of foam defines an elliptical opening 82 therein centrally positioned and substantially adjacent the rearward end 84 of the seat portion 24 of the frame for use in carrying the seat 10, as will be described. A cover 90, preferably formed of a polyester, is disposed about the seat and back support portions of the frame and the polyurethane foam. Preferably, the portion of the cover 90 disposed about the underside of the seat support 12 of seat 10 is formed of a textured PVC so as to render the bottom of the seat both water-resistant and slip resistant. In addition, a support member 92, preferably formed of a plastic material, is positioned about the perimeter portion of the opening 82 in the foam and adjacent edge portions of the cover 90 so as to define a carrying handle 94 for the seat 10 in the carrying mode. By positioning the uppermost surface 94′ of the handle proximate the rearward end 84 of the seat portion of the frame, any distortion of the interior foam adjacent the handle is prevented.

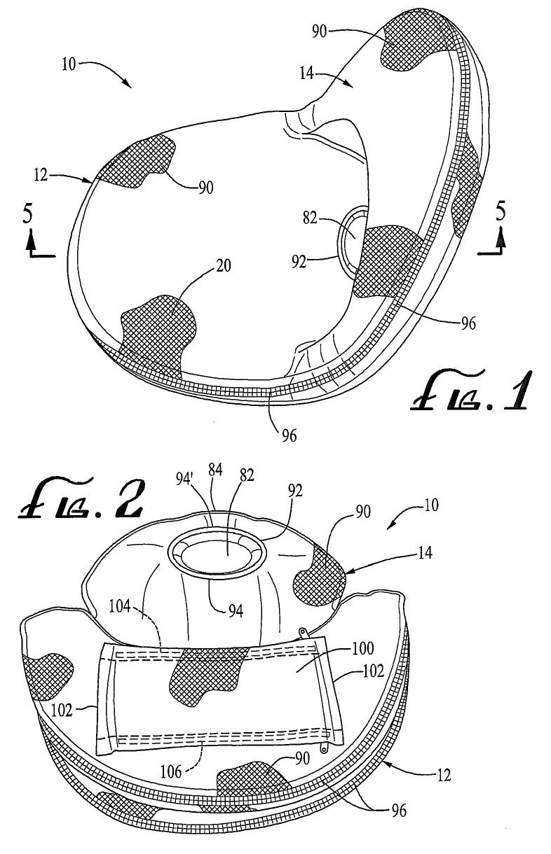

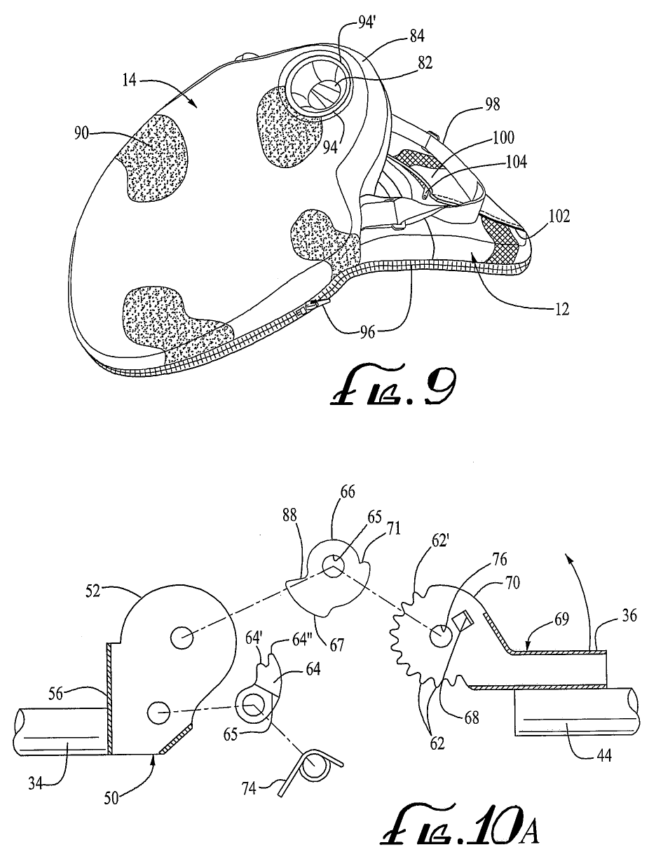

To enable the outer cover 90 to be removably disposed about the seat and back support portions of the frame and surrounding layer(s) of foam, a zipper or other suitable closure 96 may be positioned about the perimeter portions of the back support 14 and the forward half of the seat portion 12 as seen in FIGS. 1 and 9. For added convenience, an adjustable carrying strap 98 may be secured to the seat 10 proximate the juncture of the laterally-spaced lower ends of the back support and the seat portion to facilitate carrying of the seat 10 over one's shoulders in lieu of or in addition to handle 94.

A pocket 100 preferably is provided on seat 10 for carrying various small items such as sunscreen, glasses, keys, wallets, make-up, etc. In the preferred embodiment of pocket 100, a layer of material is sewn or otherwise affixed along its lateral edges 102 to the rear side of the back support as seen in FIG. 2. Zippers 104 and 106, or other closures such as hook and pile fasteners, snaps or buttons, are provided at both extended ends of the pocket such that the pocket is totally functional in both the seating and carrying modes. In the seating mode, for example, zipper 104 would define the lower end of the pocket and could be closed whereas zipper 106, which would be disposed at the upper end of the pocket, could be selectively opened and closed. In the carrying mode, the reverse would be true and zipper 106 (now positioned at the lower end of the pocket) would be closed and zipper 104, could be selectively opened and closed.

It is to be understood that various changes and modifications could be made in carrying out the present invention without departing from the spirit and scope thereof. For example, the frame could be made of varying materials and cross-sectional shapes. Different means could be used to secure together the various sections of the frame 16. The mounting members could be reconfigured and still provide the desired movement between the carrying and storage modes and the unaided adjustable support of the back support with respect to the seat portion in the sitting mode. The attachments of the mounting members to the frame sections would, of course, also be varied. Different materials could be employed in providing the desired cushioning for the seat and variations in materials could be employed in the formation of the outer cover. The seat and back supports could be formed in a variety of shapes and sizes while maintaining the above-described functionality. Such changes and modifications are by way of example only. Insofar as these and any other changes and modifications are within the purview of the appended claims, they are to be considered as part of the present invention.

What is claimed is:

1. A portable folding seat comprising a back support, a seat portion and a pair of laterally-spaced mounting assemblies extending between and operatively connecting said back support to said seat portion so as to allow reciprocal rotational movement of said back support with respect to said seat portion between a carrying mode wherein said back support is positioned over and adjacent to said seat portion and a storage mode wherein said back support is positioned adjacent to and coplanar with said seat portion and from said storage mode to a seating mode wherein said back support is disposed at an angular orientation with respect to said seat portion, said mounting assemblies additionally supporting said back support in selectively variable angles of rearward inclination in said seating mode.

2. The portable folding seat of claim 1 including an interior frame having a rigid seat section disposed within said seat portion of said portable folding seat and a rigid back support section disposed within said back support of said seat, said sections being operatively connected by said mounting assemblies, each of said mounting assemblies comprising a rotating member rigidly connected at one end thereof to a lateral portion of said back support section of said frame, each said rotating member defining a pair of laterally-spaced flanges projecting from an opposed end thereof, each of said flanges having a curvilinear end portion and defining aligned pairs of ratchet teeth in said end portions, and a spring-biased pawl operatively connected to a lateral portion of said seat section of said frame for selective engagement with said aligned pairs of ratchet teeth whereby said movement of said back support relative to said seat support and said supporting of said back support in selectively variable angles of inclination in said seating mode are obtained.

3. The portable folding seat of claim 1 including a pocket affixed to a backside of said back support, said pocket comprising laterally-spaced closed ends and vertically-spaced open ends and separate closure means disposed at each of said open ends for selectively closing and opening each of said open ends whereby one of said open ends can be closed by one of said closure means in said carrying mode and the other of said open ends can be closed in said seating mode.

4. The portable folding seat of claim 1 including an interior frame having a rigid seat section disposed within said seat portion of said portable folding seat and a rigid back support section disposed within said back support of said portable folding seat, a first cushioning member disposed about said seat section of said frame, a second cushioning member disposed about said back support section of said frame and an opening extending through said first cushioning member proximate a central portion of said seat section of said frame, said opening defining a carrying handle for said portable folding seat in said carrying mode.

5. The portable folding seat of claim 4 including a pocket affixed to a backside of said back support, said pocket comprising laterally-spaced closed ends and vertically-spaced open ends and separate closure means disposed at each of said open ends for selectively closing and opening each of said open ends whereby one of said open ends can be closed by one of said closure means in said carrying mode and the other of said open ends can be closed in said seating mode.

6. The portable folding seat of claim 1 including an interior frame having a rigid seat section disposed within said seat portion of said portable folding seat and a rigid back support section disposed within said back support of said seat, said sections being operatively connected by said mounting assemblies, each of said mounting assemblies comprising a rotating member rigidly connected at a first end thereof with respect to a lateral portion of said back support section of said frame and pivotally connected at a second end thereof with respect to a lateral portion of said seat section of said frame and wherein the rigid and pivotal connections are vertically offset whereby said back support and seat portion can be disposed in an adjacent and substantially parallel disposition in said carrying mode.

7. The portable folding seat of claim 2 including an interior frame having a rigid seat section disposed within said seat portion of said portable folding seat and a rigid back support section disposed within said back support of said portable folding seat, a first cushioning member disposed about said seat section of said frame, a second cushioning member disposed about said back support section of said frame and an aperture disposed in said first cushioning member proximate a central portion of said seat section of said frame, said aperture defining a carrying handle for said portable folding seat in said carrying mode.

8. The portable folding seat of claim 7 including a pocket affixed to a backside of said back support, said pocket comprising laterally-spaced closed ends and vertically-spaced open ends and separate closure means disposed at each of said open ends for selectively closing and opening each of said open ends whereby one of said open ends can be closed by one of said closure means in said carrying mode and the other of said open ends can be closed in said seating mode.

9. The portable folding seat of claim 4 including a removable cover disposed about said frame sections, said mounting assemblies and said first and second cushioning members, a portion of said cover disposed under said seat portion of said portable folding seat being comprised of a textured water resilient material so as to inhibit the passage of water therethrough and prevent slippage of said seat in said seating mode.

10. The portable folding seat of claim 9 including a support member extending about the perimeter of said opening in said first cushioning member and adjacent portions of said cover and a zipper closure extending about a perimeter portion of said cover whereby said cover is removable from said frame and cushioning members for cleaning and replacement.

11. The portable folding seat of claim 10 including an adjustable carrying strap, said strap being secured to laterally-spaced portions of said cover proximate said mounting assemblies therein.

12. A portable folding seat comprising a padded back support having a generally flat configuration and a rigid interior frame section disposed therein, a seat portion having a generally flat configuration and a rigid interior frame section disposed therein and a pair of laterally-spaced mounting assemblies extending between said frame sections and operatively connecting said back support to said seat portion so as to allow reciprocal rotational movement of said back support with respect to said seat portion between a carrying mode wherein said back support is positioned over and adjacent to said seat portion and a storage mode wherein said back support is positioned adjacent to and coplanar with said seat portion and from said storage mode to a seating mode wherein said back support is disposed at an angular orientation with respect to said seat portion, said mounting assemblies additionally supporting said back support in selectively variable angles of rearward inclination in said seating mode.

13. The portable folding seat of claim 12 including a removable cover disposed about said back support, seat portion and said mounting assemblies, a portion of said cover disposed under said seat portion of said portable folding seat being comprised of a textured water resilient material so as to inhibit the passage of water therethrough and prevent slippage of said seat in said seating mode.

14. The portable folding seat of claim 12 including an opening extending through said seat portion proximate a central portion of said frame section therein, said aperture defining a carrying handle for said portable folding seat in said carrying mode.

15. The portable folding seat of claim 12 including an interior frame having a rigid seat section disposed within said seat portion of said portable folding seat and a rigid back support section disposed within said back support of said seat, said sections being operatively connected by said mounting assemblies, each of said mounting assemblies comprising a rotating member rigidly connected at a first end thereof with respect to a lateral portion of said back support section of said frame and pivotally connected at a second end thereof with respect to a lateral portion of said seat section of said frame and wherein the rigid and pivotal connections are vertically offset whereby said back support and seat portion can be disposed in an adjacent and substantially parallel disposition in said carrying mode.

16. The portable folding seat of claim 13 including an opening extending through said seat portion and said cover proximate a central portion of said frame section therein, said aperture defining a carrying handle for said portable folding seat in said carrying mode.

17. The portable folding seat of claim 16 including an annular reinforcing member extending about the perimeter of said opening in said seat portion and about portions of said cover proximate said opening.

18. A portable folding seat comprising a padded back support having a generally flat configuration and a rigid interior frame section disposed therein, a seat portion having a generally flat configuration and a rigid interior frame section disposed therein and a pair of laterally-spaced mounting assemblies extending between said frame sections and operatively connecting said back support to said seat portion each of said mounting assemblies being rigidly connected at a first end thereof with respect to a lateral portion of said interior frame section in said back support and pivotally connected at a second end thereof with respect to said frame section within said seat support end wherein the rigid and pivotal connections are vertically offset, allowing reciprocal rotational movement of said back support with respect to said seat portion between a carrying mode wherein said back support is positioned over and adjacent to said seat portion and a storage mode wherein said back support is positioned adjacent to and coplanar with said seat portion and from said storage mode to a seating mode wherein said back support is disposed at an angular orientation with respect to said seat portion, said mounting assemblies additionally supporting said back support in selectively variable angles of rearward inclination in said seating mode.

19. The portable folding seat of claim 18 including a removable cover disposed about said back support, seat portion and said mounting assemblies, a portion of said cover disposed under said seat portion of said portable folding seat being comprised of a textured water resilient material so as to inhibit the passage of water therethrough and prevent slippage of said seat in said seating mode.

20. The portable folding seat of claim 18 including an opening extending through said seat portion proximate a central portion of said frame section therein, said aperture defining a carrying handle for said portable folding seat in said carrying mode.

21. The portable folding seat of claim 19 including an opening extending through said seat portion and said cover proximate a central portion of said frame section therein, said aperture defining a carrying handle for said portable folding seat in said carrying mode.

22. The portable folding seat of claim 21 including an annular reinforcing member extending about the perimeter of said opening in said seat portion and about portions of said cover proximate said opening.
